(19) United States
(12) Patent Application Publication
(10) Pub. No.: US 2011/0273049 A1
(43) Pub. Date: Nov. 10, 2011

(54) ROTOR LAMINATION ASSEMBLY

(75) Inventors: Balazs Palfai, Fishers, IN (US); Bradley D. Chamberlin, Pendleton, IN (US); David A. Fulton, Anderson, IN (US); Rui Guan, Pendleton, IN (US)

(73) Assignee: REMY TECHNOLOGIES, L.L.C., Pendleton, IN (US)

(21) Appl. No.: 12/776,973

(22) Filed: May 10, 2010

(51) Int. Cl. H02K 1/27; H02K 15/03

(52) U.S. Cl. 310/156.53; 29/598

(57) ABSTRACT

An electric machine includes a stator, and a rotor lamination assembly configured and disposed to rotate relative to the stator. The rotor lamination assembly includes at least one lamination member including a body member having an outer diametric edge, and at least one magnet receiving member. The at least one magnet receiving member includes a first end that extends to a second end. The second end establishes an interruption zone in the outer diametric edge.

### BACKGROUND OF THE INVENTION

The subject matter disclosed herein relates to the art of electric machines and, more particularly, to a rotor lamination assembly for a permanent magnet electric machine.

Electric machines include a rotor that sets up a magnetic field. Electrical current passing though a stator is influenced by the magnetic field creating an electro-motive force that causes the rotor to spin. Certain electric motors/generators employ permanent magnets in the rotor. The permanent magnets are mounted in magnet slots formed in the rotor which is typically constructed from a plurality of laminations. Generally, the permanent magnets are mounted near an outside edge of the rotor, as close to the outside edge as possible, in order to maximize torque and minimize flux losses. Mounting the permanent magnets in this manner creates a thin bridge area between the magnet slots and the outside edge of the rotor lamination.

During high speed operation, centrifugal forces on the rotor create stresses in the thin bridge area. If operated at too high a speed, the stress can exceed the yield strength of the laminations. In such a case, the rotor will fail. Accordingly, there is a trade off between maximizing torque and high speed operation. That is, maximizing torque by mounting the permanent magnets as close to the outside edge of the rotor limits the overall operational speed of the electrical machine.

### BRIEF DESCRIPTION OF THE INVENTION

According to one aspect of the invention, an electric machine includes a stator, and a rotor lamination assembly configured and disposed to rotate relative to the stator. The rotor lamination assembly includes at least one lamination member including a body member having an outer diametric edge, and at least one magnet receiving member. The at least one magnet receiving member includes a first end that extends to a second end. The second end establishes an interruption zone in the outer diametric edge.

According to another aspect of the invention, a method of forming a high speed rotor lamination for an electric machine includes forming a lamination member including a body member having an outer diametric edge, creating at least one magnet receiving member in the body member, the at least one magnet receiving member including a first end that extends to a second end, and establishing an interruption zone in the outer diametric edge at the second end of the magnet receiving member.

According to yet another aspect of the invention, a method of forming a high speed rotor lamination assembly includes forming a plurality of lamination members each of which includes a body member having an outer diametric edge, creating at least one magnet receiving member in the body member of at least one of the plurality of lamination members. The magnet receiving member including a first end that extends to a second end. The second end establishes an interruption zone in the outer diametric edge. The method also includes connecting the plurality of lamination members to form the rotor lamination assembly.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional side view of an electric machine including a rotor lamination assembly constructed in accordance with an exemplary embodiment;

FIG. 2 is a plan view of a rotor lamination in accordance with an exemplary embodiment; and

FIG. 3 is a detail view of a magnet receiving member portion of the rotor lamination of FIG. 2

The detailed description explains embodiments of the invention, together with advantages and features, by way of example with reference to the drawings.

### DETAILED DESCRIPTION OF THE INVENTION

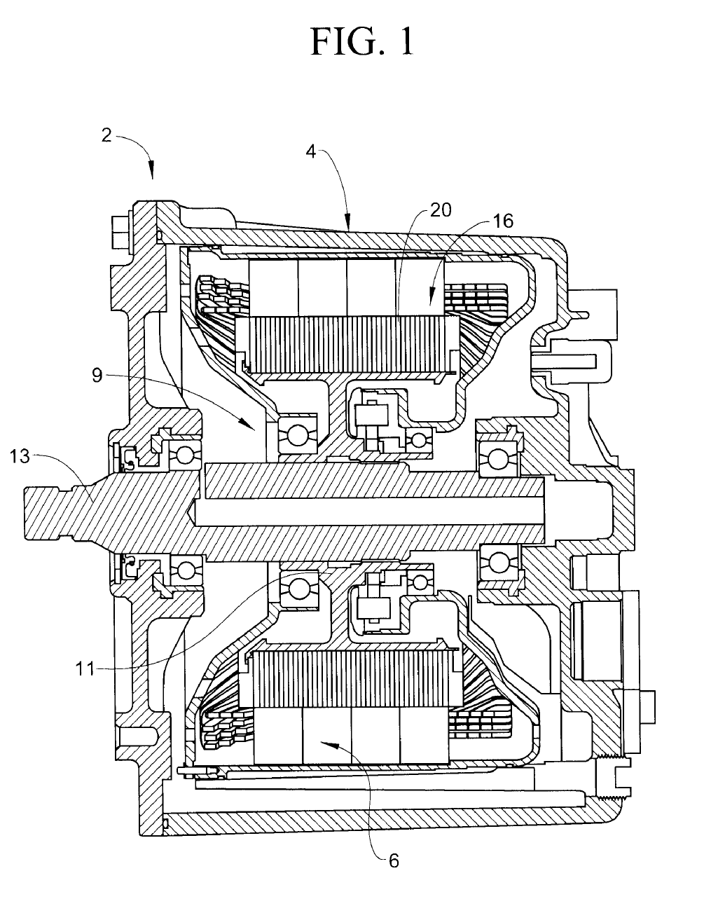

Referring to FIG. 1, an electric machine constructed in accordance with an exemplary embodiment is indicated generally at 2. Electric machine 2 includes a housing 4 having mounted thereto a stator 6. A rotor 9 rotates relative to stator 6 to produce an electro-motive force. In the exemplary embodiment shown, rotor 9 includes a hub portion 11 having mounted thereto a shaft 13. Rotor 9 includes a rotor lamination assembly 16 formed from a plurality of lamination members, one of which is indicated at 20.

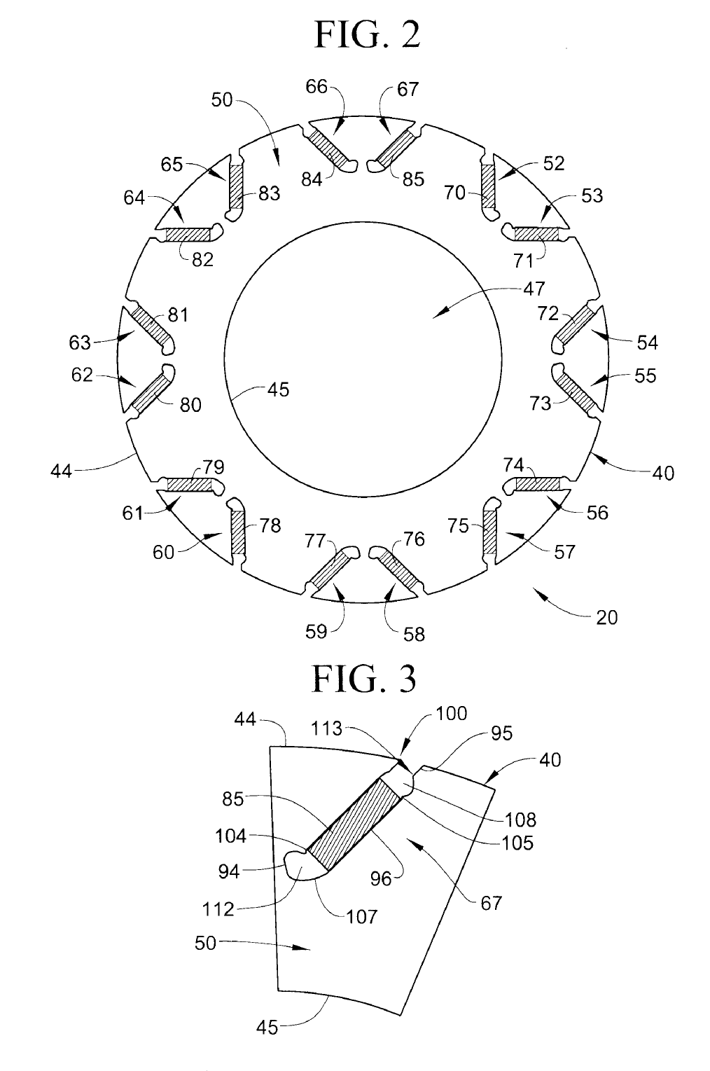

Reference will now be made to FIG. 2 in describing lamination member 20 with an understanding that one or more of the other of the plurality of lamination members include similar structure. Lamination member 20 includes a body member 40 having an outer diametric edge 44 and an inner diametric edge 45 that defines a hub receiving portion 47. Outer diametric edge 44 and inner diametric edge 45 are joined by a web 50. In the exemplary embodiment shown, lamination member 20 includes a plurality of magnet receiving slots or members 52-67 arranged in pairs and arrayed about outer diametric edge 44. Each magnet receiving member 52-67 supports a corresponding one of a plurality of magnets 70-85. With this arrangement, when joined with the others of the plurality of lamination members and rotated relative to stator 6, an electro motive force is developed.

Reference will now be made to FIG. 3 in describing magnet receiving member 67 with an understanding that the remaining magnet receiving members 52-66 are similarly formed. Magnet receiving member 67 includes a first end 94 that extends to a second end 95 through an intermediate portion 96. Second end 95 defines an interruption zone 100 in outer diametric edge 44. Magnet receiving member 67 is further shown to include first and second magnet retaining elements 104 and 105 that are configured and disposed to position magnet 85 between first and second ends 94 and 95. Magnet retaining elements 104 and 105 position magnet 85 in magnet receiving member 67 creating first and second voids 107 and 108 at first and second ends 94 and 95 respectively. Voids 107, 108 are provided with a corresponding filler material 112 and 113 that aids in the retention of magnet 85. Filler material 112 and 113 also prevents oil from entering into lamination assembly 16. With this arrangement lamination member 20 can be rotated at high speed without experiencing failure in web 50 at second end 95 of the plurality of magnet receiving member 52-67. That is by forming interruption zone 100 in lamination member 20, there no longer exists any structure that can serve as a stress concentration point at outer diametric edge 44 for forces that develop in lamination assembly 16 during high speed operations.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An electric machine comprising:
a stator; and
a rotor lamination assembly configured and disposed to rotate relative to the stator; the rotor lamination assembly comprising:
at least one lamination member including a body member having an outer diametric edge, and at least one magnet receiving member, the at least one magnet receiving member including a first end that extends to a second end, the second end establishing an interruption zone in the outer diametric edge.

2. The electric machine according to claim 1, wherein the at least one magnet receiving member includes at least one magnet retaining element formed in the body member, the at least one magnet retaining element being configured and disposed to position a magnet in the at least one lamination member.

3. The electric machine according to claim 2, further comprising: at least one magnet arranged in the at least one magnet receiving member.

4. The electric machine according to claim 3, further comprising: a filler material positioned in the at least one magnet receiving member between the first end and the at least one magnet.

5. A method of forming a high speed rotor lamination for an electric machine, the method comprising:
forming a lamination member including a body member having an outer diametric edge;
creating at least one magnet receiving member in the body member, the at least one magnet receiving member including a first end that extends to a second end;
establishing an interruption zone in the outer diametric edge at the second end of the magnet receiving member.

6. The method of claim 5, further comprising: forming a plurality of magnet retaining members in the body member.

7. The method of claim 6, further comprising: positioning a magnet within at least one of the magnet receiving members formed in the body member.

8. The method of claim 7, further comprising: adding a filler material to the at least one of the magnet receiving members between the first end and the magnet.

9. A method of forming a high speed rotor lamination assembly, the method comprising:
forming a plurality of lamination members each of which includes a body member having an outer diametric edge;
creating at least one magnet receiving member in the body member of at least one of the plurality of lamination members, the magnet receiving member including a first end that extends to a second end, the second end establishing an interruption zone in the outer diametric edge; and
connecting the plurality of lamination members to form the rotor lamination assembly.

10. The method of claim 9, further comprising: forming a plurality of magnet receiving members in the body member of each of the plurality of lamination members.

11. The method of claim 10, further comprising: mounting a magnet in at least one of the plurality of magnet receiving members.

12. The method of claim 11, further comprising: adding a filler material to the at least one of the plurality of magnet receiving members between the first end and the magnet.
